(19) United States
(12) Patent Application Publication
(10) Pub. No.: US 2021/0341731 A1
(43) Pub. Date: Nov. 4, 2021

(54) UTLRASONIC LENS CLEANER

(71) Applicant: Texas Instruments Incorporated, Dallas, TX (US)

(72) Inventors: David Patrick Magee, Allen, TX (US); Mohammad Hadi Motieian Najar, Santa Clara, CA (US)

(73) Assignee: Texas Instruments Incorporated, Dallas, TX (US)

(21) Appl. No.: 17/138,973

(22) Filed: Dec. 31, 2020

Related U.S. Application Data
(60) Provisional application No. 63/018,244, filed on Apr. 30, 2020.
(60) Provisional application No. 63/018,256, filed on Apr. 30, 2020.

(51) Int. Cl. G02B 27/00; B08B 7/02

(52) U.S. Cl. CPC G02B 27/0006; B06B 1/06; B08B 7/028

(57) ABSTRACT

An apparatus includes a lens, a transducer and a driver, where the lens has a first side, a second side, and a lens radius, and the transducer has a transducer outer radius. The transducer is coupled to the first side of the lens, and the transducer outer radius is less than the lens radius. The driver has output terminals coupled to the transducer and is configured to provide an oscillating drive signal at a non-zero frequency to vibrate the lens. An o-ring is positioned between a clamp and the second side of the lens, where the o-ring has a nominal radius that is less than or equal to a nominal radius of the transducer.

### CROSS-REFERENCE TO RELATED APPLICATIONS

This application claims priority to, and the benefit of, U.S. provisional patent application No. 63/018,244, entitled “LENS DIAMETER IN AN ULTRASONIC LENS CLEANER”, and filed on Apr. 30, 2020, the entirety of which is hereby incorporated by reference. This application also claims priority to, and the benefit of, U.S. provisional patent application No. 63/018,256, entitled “0-RING LOCATION IN AN ULTRASONIC LENS CLEANER”, and filed on Apr. 30, 2020, the entirety of which is hereby incorporated by reference.

### BACKGROUND

Optical systems, such as light sources, cameras, etc. are subject to dirt and debris buildup on a lens. Camera systems are used in automotive and other applications, such as vehicle cameras, security cameras, industrial automation systems, and in other applications and end-use systems. Operation of camera and lighting systems is facilitated by clean optical paths, which can be hindered by dirt, water or other debris, particularly in outdoor applications such as vehicle mounted camera systems, outdoor security lighting or camera systems, camera systems in industrial facilities, etc. Cameras or light source lenses may be subject to ambient weather conditions, dirt and debris, and other contaminants which can obstruct or interfere with optical transmission through the lens. In such applications, the optical system may require periodic or continuous cleaning, which can be difficult to perform manually. Self-cleaning apparatus for optical system lenses include water sprayers, mechanical wipers and air jets, as well as more cost-effective ultrasonic vibration cleaning solutions. In addition to cost constraints, battery or solar powered systems may have stringent power consumption limits for lens self-cleaning apparatus.

### SUMMARY

In accordance with one aspect, an apparatus comprises a lens, a transducer and a driver. The lens has a first side, a second side, and a lens radius. The transducer has a transducer outer radius that is less than the lens radius. The transducer is coupled to the first side of the lens. The driver has output terminals coupled to the transducer to provide an oscillating drive signal at a non-zero frequency to vibrate the lens.

In another aspect, an apparatus comprises a lens with first and second sides, a transducer coupled to the first side of the lens, an o-ring between a clamp and the second side of the lens, and a driver. The o-ring has a nominal radius that is less than or equal to a nominal radius of the transducer, and the driver has output terminals coupled to the transducer to provide an oscillating drive signal at a non-zero frequency to vibrate the lens.

In a further aspect, a method comprises providing an oscillating drive signal to a transducer coupled to vibrate a lens in a first frequency range that includes a first non-zero resonant frequency of a bimodal vibration frequency response of the lens for a first non-zero cleaning time, and providing the oscillating drive signal to the transducer coupled to vibrate the lens in a second frequency range that includes a second non-zero resonant frequency of the bimodal vibration frequency response of the lens for a second non-zero cleaning time.

### BRIEF DESCRIPTION OF THE DRAWINGS

FIG. 1 is a schematic diagram of an ultrasonic lens cleaning system with a driver integrated circuit.

FIG. 2 is a partial sectional side elevation view of a camera lens assembly including an ultrasonic lens cleaning system, a curved lens, and an o-ring with a round cross section.

FIG. 3 is a partial sectional side elevation view of another camera lens assembly including an ultrasonic lens cleaning system, a flat lens, and an o-ring with a round cross section.

FIG. 4 is a partial sectional side elevation view of a camera lens assembly including an ultrasonic lens cleaning system, a flat lens, and an o-ring with a rectangular cross section.

FIG. 5 is schematic diagram of an example control and sensing architecture for the ultrasonic lens cleaning systems of FIGS. 1-4.

FIG. 6 is a graph of example impedance magnitude and phase angle response curves as a function of excitation frequency.

FIG. 7 is a graph of lens admittance as a function of excitation frequency for different lens outer radiuses in the lens cleaning systems of FIGS. 1 and 3.

FIG. 8 is a graph of maximum lens acceleration as a function of excitation frequency for different lens outer radiuses in the lens cleaning systems of FIGS. 1 and 3.

FIG. 9 is a graph of lens admittance as a function of excitation frequency for different o-ring nominal radiuses in the lens cleaning systems of FIGS. 1 and 3.

FIG. 10 is a graph of maximum lens acceleration as a function of excitation frequency for different o-ring nominal radiuses in the lens cleaning systems of FIGS. 1 and 3.

FIG. 11 is a flow diagram of a method of ultrasonically cleaning a lens.

### DETAILED DESCRIPTION

In the drawings, like reference numerals refer to like elements throughout, and the various features are not necessarily drawn to scale. Also, the term “couple” or “couples” includes indirect or direct electrical or mechanical connection or combinations thereof. For example, if a first device couples to or is coupled with a second device, that connection may be through a direct electrical connection, or through an indirect electrical connection via one or more intervening devices and connections. One or more operational characteristics of various circuits, systems and/or components are hereinafter described in the context of functions which in some cases result from configuration and/or interconnection of various structures when circuitry is powered and operating.

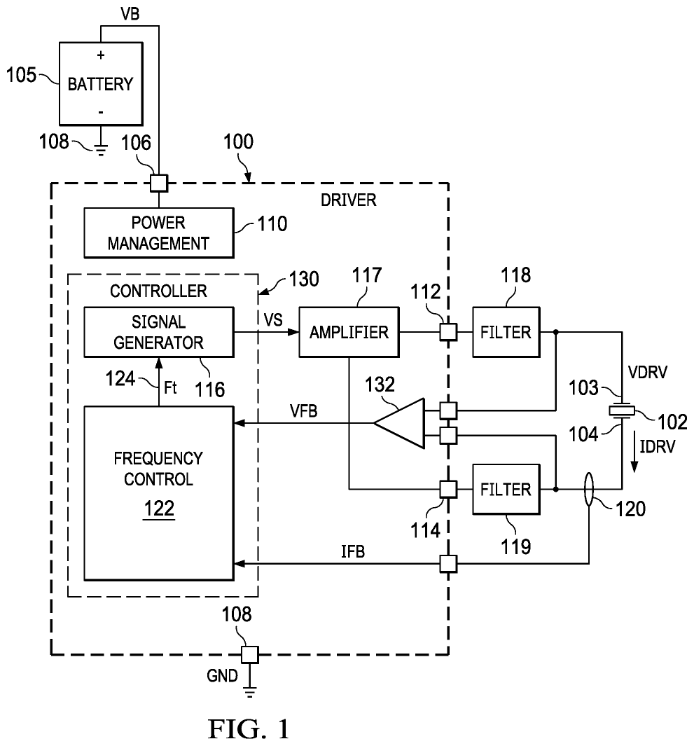

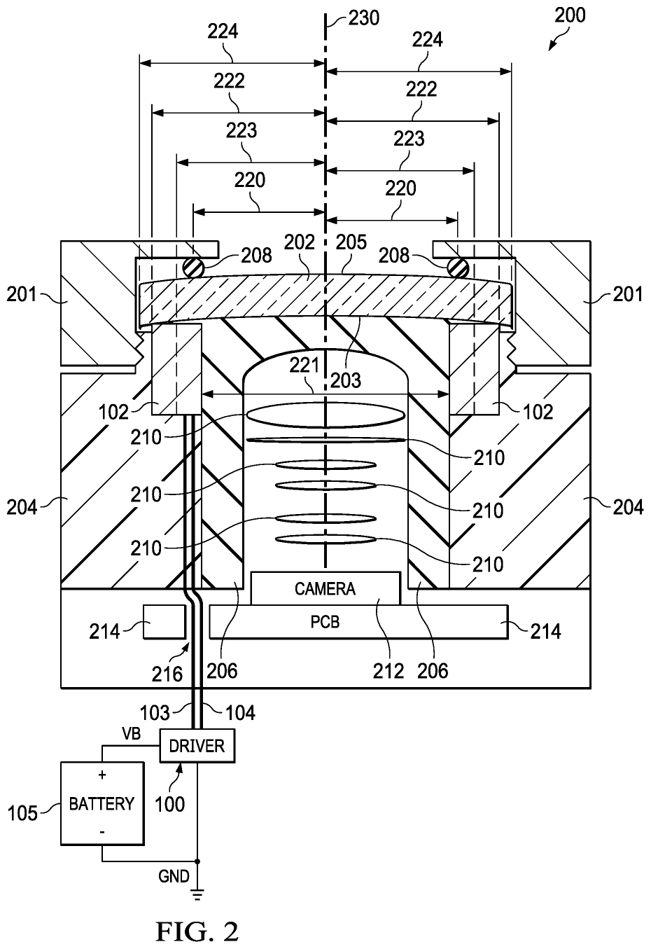

Referring initially to FIGS. 1 and 2, FIG. 1 shows an ultrasonic lens cleaning system with a driver integrated circuit (IC) 100 operatively coupled to a lens. The ultrasonic lens cleaning system includes a transducer 102 having lead wires or terminals 103 and 104 for coupling to the driver IC 100. The system operates on power from a power source, such as a battery 105 with an output terminal coupled to a power input terminal 106 of the driver 100 to provide a battery voltage signal VB with respect to a reference node 108 having a reference voltage (e.g., GND). The power input terminal 106 in one example is an IC pin or pad that is coupled to the battery output terminal to receive input power from the battery 105. The output terminal of the battery 105 provides a battery voltage signal VB to a power management circuit 110 of the driver IC 100. The power management circuit 110 provides one or more supply voltages (not shown) to power the internal circuitry of the driver 100. The driver IC 100 includes an output with output terminals 112 and 114 for connection to the terminals 103 and 104, respectively, of the transducer 102. In operation, the output terminals 112 and 114 of the driver IC 100 provide an oscillating drive signal VDRV to the terminals 103 and 104 at a non-zero frequency Ft to vibrate a lens, as shown in FIGS. 2-4 below.

The driver IC 100 also includes a signal generator 116 with a pulse width modulation (PWM) processor output that generates a square wave signal VS at the frequency Ft to an input terminal of an amplifier 117. The amplifier 117 has first and second output terminals coupled to input terminals of respective filter circuits 118 and 119. Output terminals of the filter circuits 118 and 119 are coupled to the respective transducer terminals 103 and 104 to deliver the oscillating drive signal VDRV to the transducer 102.

The driver IC 100 also includes a feedback circuit with a current sensor or current transducer 120 that generates a current feedback signal IFB representing a current IDRV flowing in the transducer 102. The driver IC 100 also includes 1 frequency control circuit 122 with an output terminal 124 that provides the desired frequency Ft to the signal generator circuit 116. In one example, the driver IC 100 includes a controller or control circuit 130 that includes the signal generator 116 and the frequency control circuit 122. In one example, the controller 130 is or includes a processor with an associated electronic memory. The controller 130 implements various cleaning functions by controlling the oscillatory frequency Ft of the oscillating drive signal VDRV provided to the transducer 102. The driver IC 100 further includes a differential amplifier 132 with input terminals coupled to the transducer output terminals 112 and 114, as well as an amplifier output terminal coupled to an input terminal of the frequency control circuit 122. In operation, the amplifier output terminal generates a voltage feedback signal VFB that represents the transducer voltage across the transducer terminals 103 and 104. The feedback circuit in one example includes a differential amplifier 132 with inputs connected to the transducer output terminals 112 and 114. The differential amplifier 132 has an amplifier output that generates a voltage feedback signal VFB representing the transducer voltage. The feedback circuit delivers the feedback signals IFB and VFB to the controller 130. In one example, the controller 130 includes analog-to-digital (A/D) converters to convert the current and voltage feedback signals IFB and VFB to digital values. In one possible implementation, the controller 130, the amplifier 117 and the feedback circuitry are fabricated in a single integrated circuit 100.

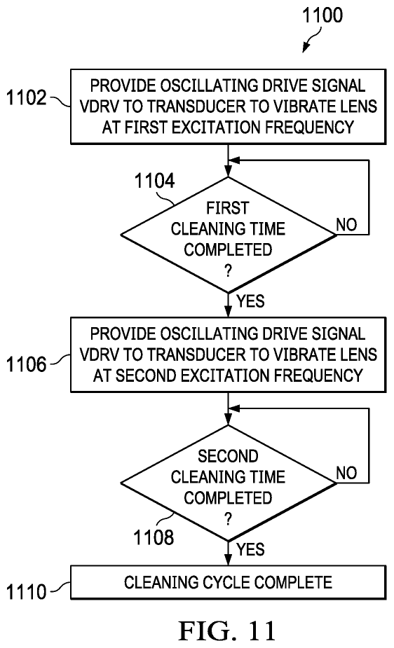

In one implementation, the controller 130 is implemented in a processor, such as a DSP or other programmable digital circuit, which implements a multiple frequency cleaning cycle as detailed further below in connection with FIG. 11 through execution of instructions stored in an associated memory to generate the frequency Ft as a digital value representing a desired frequency Ft of the drive signal VDRV. In certain implementations, the controller 130 includes an integral electronic memory, or is operatively connected to an external electronic memory, which stores program instructions implemented by the processor. In one example, the signal generator 116 is a pulse width modulation (PWM) output of the processor that implements the controller 130. The signal generator circuit 116 provides an output signal VS that oscillates at a non-zero frequency Ft. The amplifier 117 amplifies the output signal VS to generate the oscillating drive signal VDRV. In this manner, the controller 130 controls the frequency Ft of the drive signal VDRV and controls the oscillatory frequency of the transducer 102 for lens cleaning operations. In one example, the amplifier 117 is a full H-bridge amplifier circuit with first and second outputs individually coupled with the transducer terminals 103 and 104 to provide the oscillating drive signal VDRV to the transducer 102. In one example, the filter circuits 118 and 119 are L-C filters connected between the amplifier outputs and the respective transducer terminals 103 and 104.

The signal generator circuit 116 in one example is a PWM processor with an output that generates a square wave signal VS. In another example, the signal generator circuit 116 provides a sinusoidal waveform having a non-zero signal frequency Ft. In another example, the signal generator circuit 116 provides a triangular waveform having a non-zero signal frequency Ft. In another example, the signal generator circuit 116 provides a saw tooth waveform having a non-zero signal frequency Ft. In another example, the signal generator circuit 116 provides a different waveform having a non-zero signal frequency Ft. In one example, the first output of the amplifier 117 delivers an oscillating drive signal to the transducer 102 and the second amplifier output delivers an oscillating drive signal to the transducer 102 which is 180 degrees out of phase with respect to the first output. In another example, the amplifier 117 provides a single ended output through the first filter circuit 118 to the first output terminal 112, and the return current from the transducer 102 flows through the second filter circuit 119 to return to the second output of the amplifier 117. In one example, the amplifier 117 provides a differential output to the filters 118, 119. In one example, the individual filter circuits 118 and 119 each include a series inductor and a capacitor connected between the second inductor terminal and a common reference voltage (e.g., GND) to deliver the amplified signal to the transducer 102. In this manner, the amplifier 117 amplifies the signal generator output signal VS and delivers an oscillating drive signal VDRV to the transducer 102. The filter circuit 119 in one example facilitates use of a square wave output from the PWM signal generator 116 to provide a generally sinusoidal oscillating signal VDRV to vibrate the transducer 102 and a mechanically coupled lens.

FIG. 2 shows a partial sectional side elevation view of a camera lens assembly 200 including a clamp 201 (e.g., a fastener) that secures a lens 202. The lens assembly 200 includes the transducer 102, which is mechanically coupled (e.g., glued) to a first side 203 of the lens 202. The clamp 201 secures the lens 202 to a housing or enclosure 204 with a second side 205 of the lens 202 facing outward. The transducer 102 is secured in the housing 204 by a cylindrical spacer 206. In one example, an o-ring 208 extends between a contact point of the lens 202 and the clamp 201. In this or another example, the o-ring 208 provides a seal to prevent ingress of water and debris into an interior of the housing 204. In these or another example, the transducer 102 is a cylindrical or “ring” transducer 102. In one example, the transducer 102 is glued to the lens 202. In another example, the o-ring 208 is engaged to the lens 202 at a contact location so that an admittance response of the transducer 102 and lens 202 is maximized, and the resulting vibration level of the lens 202 is maximum.

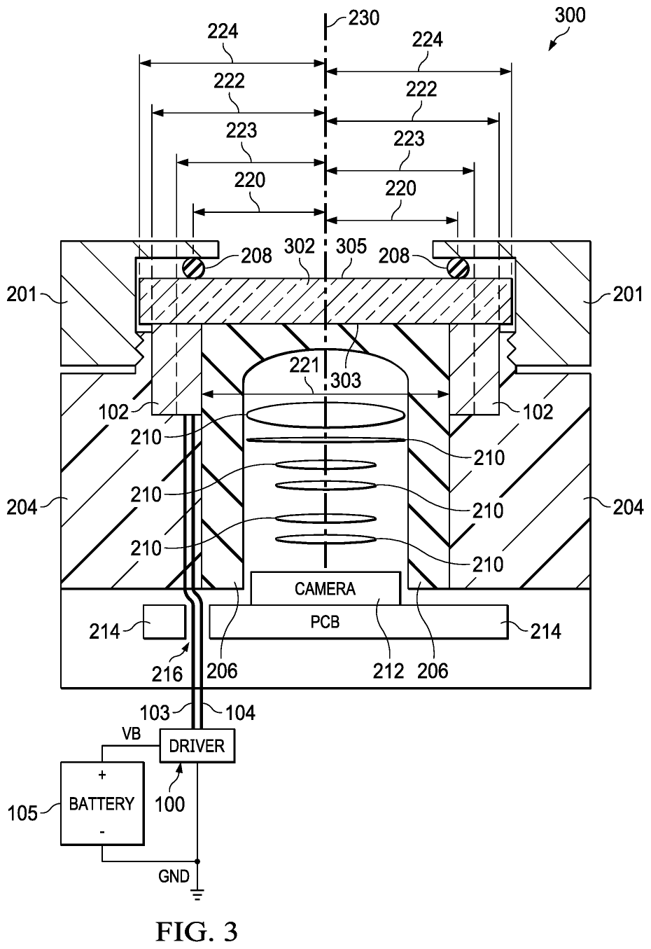

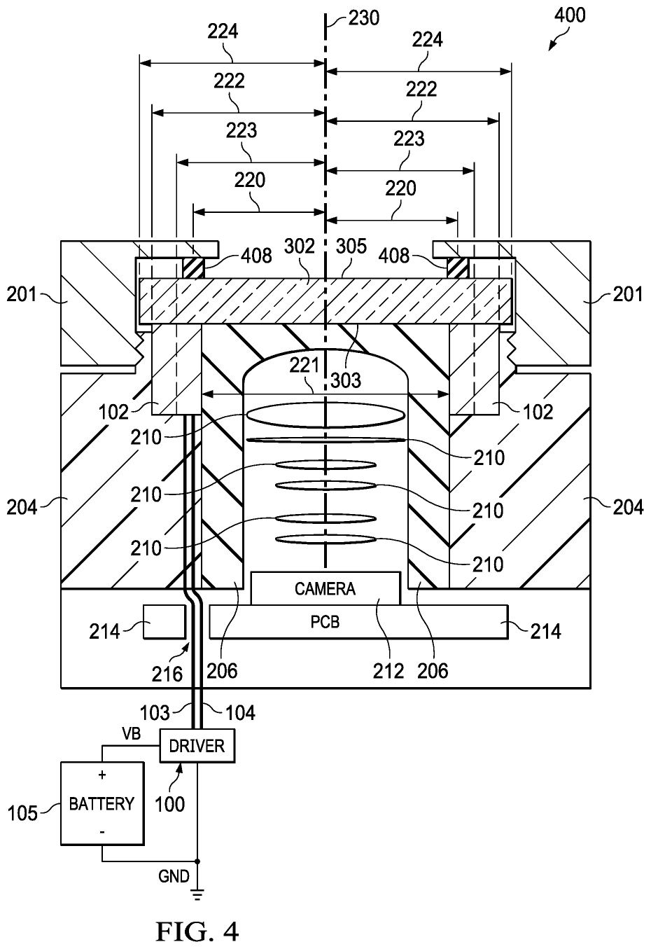

In the example of FIG. 2, the lens 202 is curved. Although illustrated in the context of a camera lens system, in another example, various techniques of the this description are used in lighting systems or other optical systems, with or without a camera. As used herein, a lens is a focusing element or other lens that implements optical shaping or other optical effect to aid camera imaging, as well as a lens cover or optical window that merely provides protection for further optical elements without performing any imaging functions. The lens 202 in one example is a “fisheye” lens having a curved outer surface as shown in FIG. 2. In another example, a flat lens is used, as shown in FIGS. 3 and 4 described below. In another example, a lens is used that has a different profile or shape.

In one example, the housing 204 is adapted to be mounted to a motor vehicle to operate as lens cover for a rear backup camera, a forward-facing camera or a side-facing camera. In other examples, the assembly 200 is configured to be mounted to a building or a light pole, for example, for security camera or lighting applications. In other examples, the assembly 200 is adapted to be used for interior security monitoring systems, such as within a commercial or residential building, a parking lot, etc. A series of generally flat secondary lenses 210 are disposed within the interior of the cylindrical spacer 206. The secondary lenses 210 and the fisheye lens 202 in this example provide an optical path for imaging by a camera 212. In the example of FIG. 2, the lens 202 is mounted into the cylindrical housing 204 with a cylindrical inner spacer structure 206. The transducer 102 in this example is a cylindrical ring-shaped piezo-electric transducer disposed between the inner spacer 206 and the outer wall of the housing 204. The terminals or terminals 103 and 104 of the transducer 102 extend through an opening 216 in a printed circuit board (PCB) 214 that forms a base of the housing 204 for connection with the driver IC 100.

In operation, the output of the driver IC 100 provides the oscillating drive signal VDRV at the non-zero frequency Ft to the transducer 102 to vibrate the lens 202, in order to remove water, debris, and other obstructions from the outer second side 205 of the lens 202. The driver IC 100 in one example is provided on the PCB 214 along with the camera 212 (or a light source) to provide a compact solution for various vehicle-based and/or security camera systems for lighting systems generally. In another example, the camera 212 is omitted and replaced with a light source (e.g., an LED or LED array). In operation, the driver IC 100 selectively provides ultrasonic lens cleaning functions in conjunction with the transducer 102. Mechanical oscillation or motion of the lens 202 at ultrasonic waves of a frequency at or close to a system resonant frequency can facilitate energy efficient removal of water, dirt and/or debris from the lens 202. The driver IC 100 in one example provides a closed loop system using the feedback signals IFB and/or VFB during lens cleaning operation. In one example, the driver IC 100 regulates operation at or near a local minima or maxima in a current or impedance signal value ascertained from the current feedback signal IFB. The controller 130 in one example uses the converted feedback values to implement closed-loop control in driving the transducer 102 in a selected frequency range for lens cleaning operations.

The controller 130 in one example provides cleaning at first and second transducer frequencies Ft or ranges of frequencies. In the illustrated examples, moreover, the dimensions, configuration and positioning of the lens 202, the transducer 102 and/or the o-ring 208 provide a mechanical system in which the lens 202 exhibits a bimodal vibration frequency response having multiple (e.g., two) primary transducer impedance local minima at associated non-zero transducer frequencies. Also, the relative outer radiuses of the lens 202 and the transducer 102, and/or the relative nominal radiuses of the transducer 102 and the o-ring 208 are set to provide enhanced bimodal vibration frequency response with low mechanical impedance and high efficiency of the lens 202 at first and second resonant frequencies. In one example, the controller 130 provides the oscillating drive signal VDRV to the transducer 102 to vibrate the lens 202 in a first frequency range that includes a first non-zero resonant frequency of the bimodal vibration frequency response of the lens 202 for a first non-zero cleaning time, and provides the oscillating drive signal VDRV in a second frequency range that includes a second non-zero resonant frequency of the bimodal vibration frequency response of the lens 202 for a second non-zero cleaning time. This example two stage cleaning cycle facilitates energy efficient lens cleaning to remove debris, water, etc.

The o-ring 208 in FIG. 2 has a nominal radius 220, determined as the average of an inner o-ring radius and an outer o-ring radius. The o-ring 208 in FIG. 2 has a round cross section. The cylindrical transducer 102 has an inner diameter 221, an outer radius 222, and a nominal radius 223, where the nominal radius 223 is the average of the outer radius 222 and half the inner diameter 221. Also, the lens 202 has a lens radius 224 as shown in FIG. 2. The cylindrical transducer 102, the lens 202 and the o-ring 208 are concentric with one another, and an axis 230 of the transducer 102 is aligned with an axis of the lens 202. In the example of FIG. 2, the transducer outer radius 222 is less than the lens radius 224. In this example, moreover, the nominal radius 220 of the o-ring 208 is less than or equal to the nominal radius 223 of the transducer 102.

As described further below in connection with FIG. 11, the driver IC 100 in one example performs a multiple frequency cleaning cycle that includes first and second stages or portions. In a first stage of a given cleaning cycle, the driver IC 100 provides the oscillating drive signal VDRV in a first frequency range that includes a first non-zero resonant frequency of a bimodal vibration frequency response of the lens 202 for a first non-zero cleaning time. In a second stage of the given cleaning cycle, the driver IC 100 provides the oscillating drive signal VDRV in a second frequency range that includes a second non-zero resonant frequency of the bimodal vibration frequency response of the lens 202 for a second non-zero cleaning time. By correctly adjusting the duration and periodicity of the excitation signal, foreign materials, such as water, can be expelled from the lens surface.

FIG. 3 shows another example camera lens assembly 300 that includes the ultrasonic lens cleaning system with components and features 100, 102, 103, 104, 105, 201, 204, 206, 208, 210, 212, 214, 220, 221, 222, 223, 224 and 230 as generally described above in connection with FIGS. 1 and 2. In this example, the system includes a flat glass lens 302, and the o-ring 208 with a round cross section. The flat disc lens 302 in one example provides covering protection for a standard lens camera 212 having a field-of-view (FOV) of less than 60°, whereas the curved lens 202 of FIG. 2 above is useful cameras with a FOV between 60° and 190° (e.g., wide-angle lens). The flat lens 302 in FIG. 3 has a flat first side 303 and a flat second side 305.

FIG. 4 is a partial sectional side elevation view of a camera lens assembly including an ultrasonic lens cleaning system, a flat lens, and an o-ring with a rectangular cross section. FIG. 4 shows another example camera lens assembly 400 that includes the ultrasonic lens cleaning system with a flat lens 302 as described above, as well as an o-ring 408 having a rectangular cross section. The system 400 also includes components and features 100, 102, 103, 104, 105, 201, 204, 206, 208, 210, 212, 214, 220, 221, 222, 223, 224, 230, 303 and 305 as generally described above in connection with FIGS. 1-3.

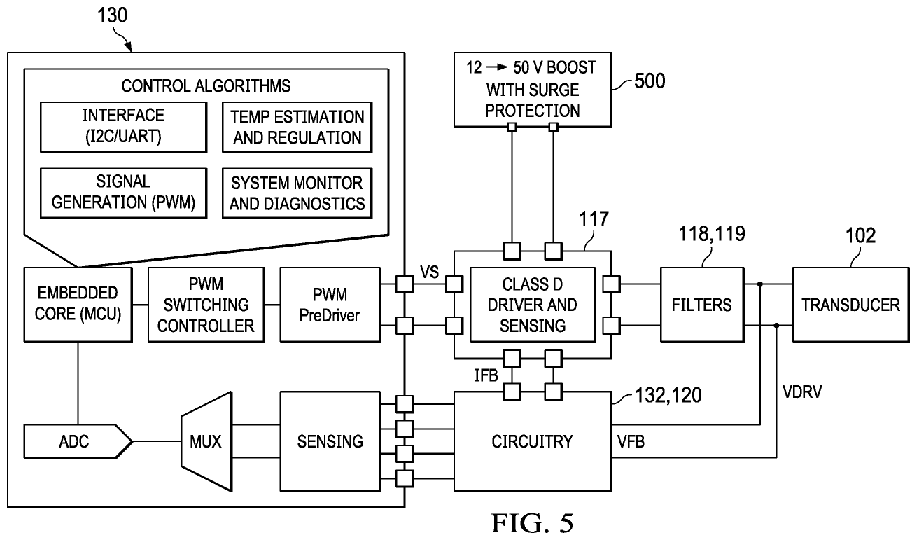

FIG. 5 shows an example control and sensing architecture for the ultrasonic lens cleaning systems of FIGS. 1-4. In this example, the controller 130 implements control algorithms including serial communications interface, such as an I²C universal asynchronous receiver transmitter (UART), temperature estimation and regulation, system monitoring and diagnostics, as well as PWM signal generation. The controller 130 has an embedded core microcontroller unit (MCU) that provides desired frequency signaling to a PWM switching controller that provides a PWM signal to a PWM pre-driver circuit. A sensing interface circuit receives feedback signals from the differential amplifier 132 and from the current transducer 120 and provides current and voltage feedback to an analog to digital converter (ADC) through a multiplexer (MUX). The ADC provides converter feedback values to the MCU for closed-loop regulation or control of the output frequency of the signal generator output signal VS. The amplifier 117 in one example is a class D driver and includes the current transducer 120 in a separate driver and sensing circuit IC in the implementation of FIG. 5. A boost converter 500 provides a supply voltage to operate the driver and sensing circuit IC 117, 120. In operation, the controller 130 generates the excitation signals to clean the lens 202, 302 and computes the PWM switching times for the PWM switching controller.

The PWM pre-driver provides on/off signaling to switches in the class D driver. In one example, the class D driver includes a full H-bridge that provides up to +/−50 V to the circuit that includes the filters 118 and 119 and the transducer 102. The sense circuitry provides current and voltage signals that get sampled by the analog-to-digital converter (ADC). The MCU computes PWM timing values according to the sampled and converted current and voltage feedback, performs temperature estimation and regulation and performs system monitoring and diagnostics.

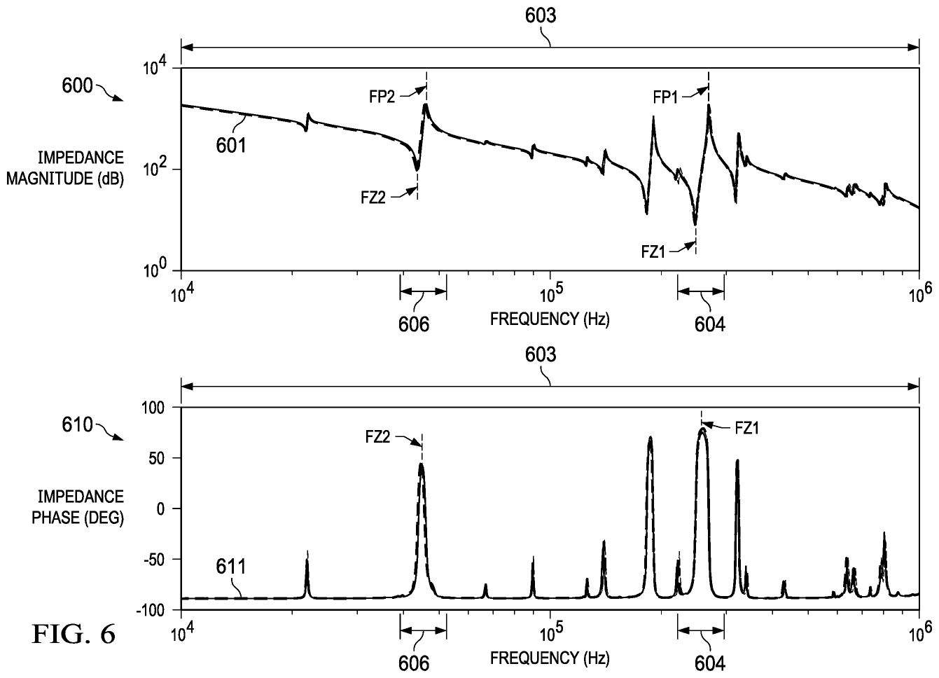

FIG. 6 shows respective graphs 600 and 610 of example impedance magnitude and phase angle response curves 601 and 611 of the attached transducer 102, the lens 202, 302 and the o-ring 208, 408 as a function of excitation frequency. The mechanical properties of the lens 202, 302, the transducer 102 and the coupling to the housing 201, 204 by the o-ring 208, 408 provide a system transfer function with poles and zeros represented in FIG. 6 as a frequency dependent impedance Z (Ω in graph 600) and a phase angle (graph 610). The zeros in the impedance magnitude response (curve 601) correspond to the mechanical resonances of the system, which are resonant frequencies where larger vibration amplitudes will occur for a given input amplitude.

The relative sizing of the transducer outer radius 222 and the lens radius 224 and/or the relative sizing of the nominal radius 220 of the o-ring 208 and the nominal radius 223 of the transducer 102 are set in certain examples to provide a bimodal vibration frequency response with two primary zeros and corresponding resonant frequencies. In one example, the transducer outer radius 222 is less than the lens radius 224. In another example, the nominal radius 220 of the o-ring 208 is less than or equal to the nominal radius 223 of the transducer 102. In another example, the transducer outer radius 222 is less than the lens radius 224, and the nominal radius 220 of the o-ring 208 is less than or equal to the nominal radius 223 of the transducer 102. In these and other implementations, the controller 130 is programmed with two or more such resonant frequencies corresponding to the zeros of the bimodal vibration frequency response of the mechanical system and performs cleaning in two or more ranges that include the corresponding resonant frequencies, in order to provide energy efficient lens cleaning in a given cleaning cycle. The cleaning system in this regard uses the mechanical behavior along with properly designed drive signals to expel foreign material from the lens 202, 302 in a timely and power efficient manner. The controller 130 in one example stores an impedance profile or profiles in a memory of the lens cleaning system (e.g., a memory of the driver IC 100), and performs cleaning at one or more frequencies in each of two or more frequency ranges of interest that include a zero frequency FZ of the impedance profile. The graph 600 that illustrates an example impedance magnitude response curve 601 as a function of transducer excitation frequency over a wide range 603, such as 10 to 1000 kHz in one implementation. Other ranges may be used, for example, covering a usable range depending on the various masses of the structural components used in the optical system generally and the lens cleaning system. FIG. 6 also shows the graph 610 with an example phase angle response curve 611 as a function of transducer excitation frequency over the same wide frequency range 603. The impedance curve 601 includes several local maxima corresponding to poles of the mechanical system, as well as a number of local minima corresponding to system zeros. A local maxima of the phase curve 611 is at the geometric mean between the pole and zero frequencies of the impedance curve 601. The graphs 600 and 610 depict several distinct frequency ranges having corresponding poles FP and zeros FZ, including a first identified frequency range of interest 604 having a pole FP1 and a zero FZ1, as well as a second identified frequency range of interest 606 that includes a pole FP2 and a zero FZ2.

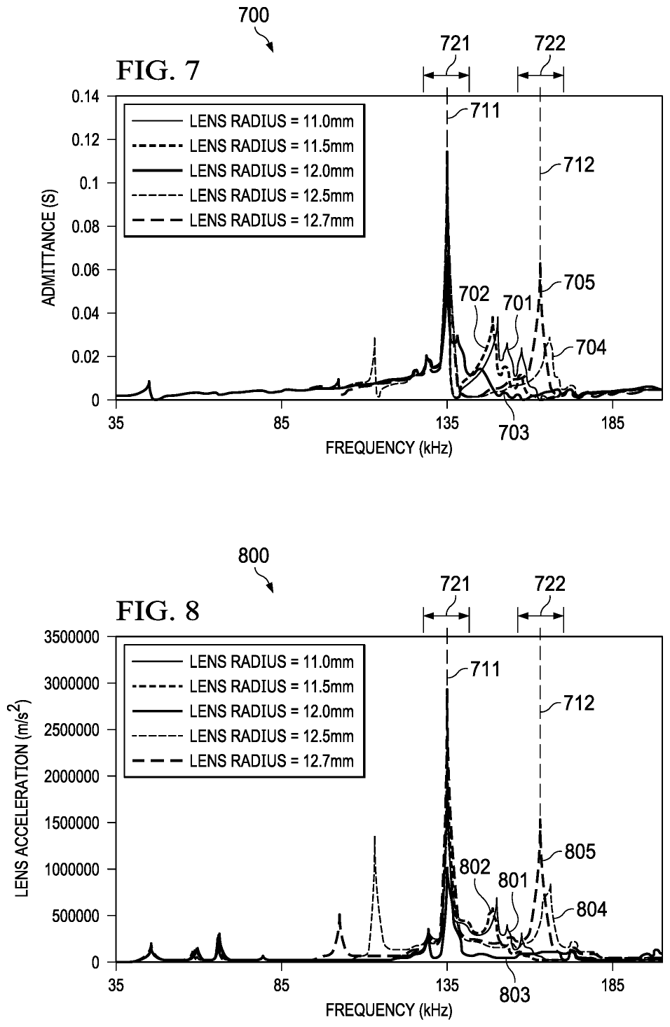

FIGS. 7 and 8 show improved cleaning efficiency and bimodal lens frequency response based on selection of lens radius and transducer radius. FIG. 7 shows a graph 700 with curves 701, 702, 703, 704 and 705 of lens admittance as a function of excitation frequency for different lens outer radiuses 224 in the lens cleaning systems of FIGS. 1 and 3 for a cylindrical transducer 102 with an inner diameter 221 of 20 mm (an inner radius of 10 mm), and an outer radius of 11 mm. The curve 701 corresponds to a lens outer radius 224 of 11.0 mm. The curve 702 corresponds to a lens outer radius 224 of 11.5 mm. The curve 703 corresponds to a lens outer radius 224 of 12.0 mm. The curve 704 corresponds to a lens outer radius 224 of 12.5 mm. The curve 705 corresponds to a lens outer radius 224 of 12.7 mm. In the illustrated example with a transducer 102 having an inner radius of 10 mm and an outer radius of 11 mm, the example admittance response curves show bimodal frequency response occurs for the transducer outer radius 222 that is less than the lens outer radius 224, with a particular lens radius 224 of 12.7 mm having a peak mode at a first resonant frequency 711 of 135 kHz in a first frequency range 721, and a second mode at a second resonant frequency 712 of about 160 kHz in a second frequency range 722.

FIG. 8 shows a graph 800 with curves 801, 802, 803, 804 and 805 of maximum lens acceleration as a function of excitation frequency for different lens outer radiuses 224 in the lens cleaning systems of FIGS. 1 and 3. The lens outer radiuses 224 and transducer 102 in FIG. 8 correspond to those for the admittance graph 700 of FIG. 7. The curve 801 corresponds to the lens outer radius 224 of 11.0 mm. The curve 802 corresponds to the lens outer radius 224 of 11.5 mm. The curve 803 corresponds to the lens outer radius 224 of 12.0 mm. The curve 804 corresponds to the lens outer radius 224 of 12.5 mm. The curve 805 corresponds to the lens outer radius 224 of 12.7 mm. The lens acceleration performance peaks in FIG. 8 correspond with the peak frequencies shown in FIG. 7. The acceleration curves 801-805 also exhibit a bimodal response.

The curve 805 has the highest acceleration peak at the first resonant frequency 711 of 135 kHz in the first frequency range 721, and the curve 805 has a second mode at the second resonant frequency 712 in the second frequency range 722. In the examples of FIGS. 7 and 8, the lens radius 224 exceeds the outer radius 222 of the transducer 102, and the second mode appears near 160 kHz. This second mode further enhances the cleaning performance of the ultrasonic lens cleaning system. The bimodal response facilitates dual frequency cleaning cycles and allows several design tradeoffs to achieve higher admittance for cleaning or lower the excitation voltage to the transducer for a target level of admittance. As a result, the system uses less power during the cleaning process.

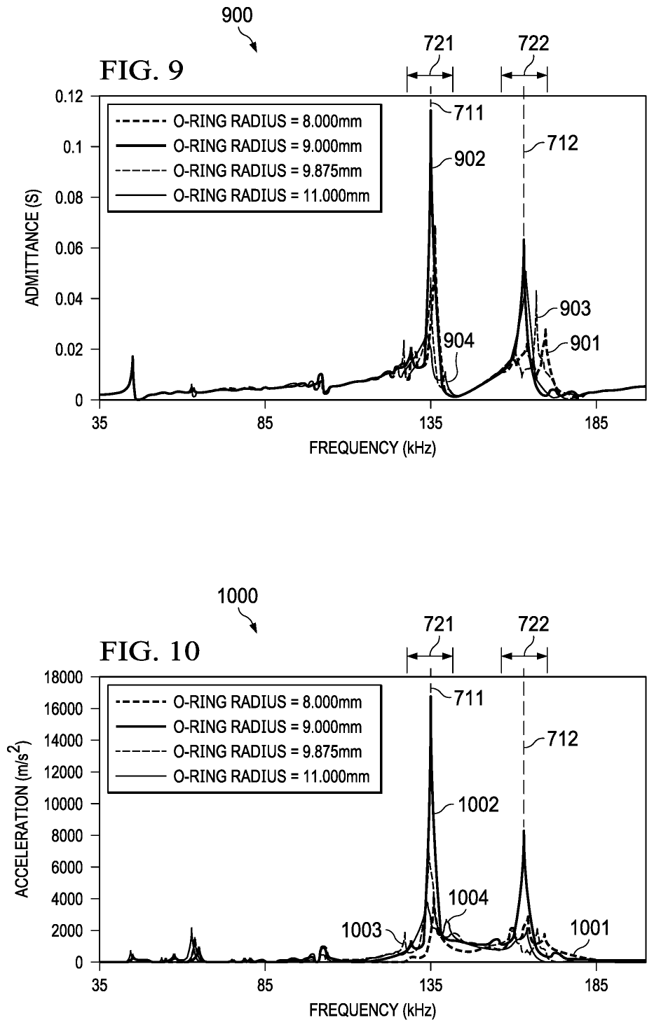

FIGS. 9 and 10 show improved cleaning efficiency and bimodal lens frequency response based on selection of the nominal radius 220 of the o-ring 208 at a value less than or equal to the nominal radius 223 of the transducer 102. This relationship, alone or in combination with providing the lens radius 224 greater than the outer radius 222 of the transducer 102, facilitates bimodal frequency response of the lens 202, 302. FIG. 9 shows a graph 900 with curves 901, 902, 903 and 904 of lens admittance as a function of excitation frequency for different nominal o-ring radiuses 220 in the lens cleaning systems of FIGS. 1 and 3 for a cylindrical transducer 102 with an inner diameter 221 of 20 mm (an inner radius of 10 mm), an outer radius of 11 mm, and a nominal transducer radius 223 of 10.5 mm. The curve 901 corresponds to a nominal o-ring radius 220 of 8.0 mm. The curve 902 corresponds to a nominal o-ring radius 220 of 9.0 mm. The curve 903 corresponds to a nominal o-ring radius 220 of 9.875 mm. The curve 904 corresponds to a nominal o-ring radius 220 of 11.0 mm. In the illustrated example with a transducer 102 having a nominal radius 223 of 9.5 mm, the example admittance response curves 901-901 show bimodal frequency response occurs for the transducer nominal radius 223 that is greater than or equal to the o-ring nominal radius 220. A particular o-ring nominal radius 220 of 9.0 mm has a peak mode at the first resonant frequency 711 of 135 kHz in the first frequency range 721, and a second mode at the second resonant frequency 712 of about 160 kHz in the second frequency range 722.

FIG. 10 shows a graph 1000 with curves 1001, 1002, 1003 and 1004 of maximum lens transverse acceleration as a function of excitation frequency for different o-ring nominal radiuses 220 in the lens cleaning systems of FIGS. 1 and 3. The o-ring nominal radiuses 220 and transducer 102 in FIG. 10 correspond to those for the admittance graph 900 of FIG. 9. The curve 1001 corresponds to the nominal o-ring radius 220 of 8.0 mm. The curve 1002 corresponds to the nominal o-ring radius 220 of 9.0 mm. The curve 1003 corresponds to the nominal o-ring radius 220 of 9.875 mm. The curve 1004 corresponds to nominal o-ring radius 220 of 11.0 mm. The lens acceleration performance peaks in FIG. 10 correspond with the peak frequencies shown in FIG. 9. The acceleration curves 1001-1005 also exhibit a bimodal response. The curve 1002 in FIG. 10 has the highest acceleration peak at the first resonant frequency 711 of 135 kHz in the first frequency range 721. The curve 1002 also has a second mode at the second resonant frequency 712 near 160 kHz in the second frequency range 722.

FIG. 11 shows a method 1100 of ultrasonically cleaning a lens. In one example, the controller 130 of FIG. 1 implements the method 1100. The method 1100 includes providing an oscillating drive signal VDRV at 1102 to the transducer 102 that is coupled to vibrate the lens 202, 302. The controller 130 in one example provides the oscillating drive signal VDRV at 1102 in the first frequency range 721 that includes the first non-zero resonant frequency 711 of the bimodal vibration frequency response of the lens 202, 302. The controller determines at 1104 whether the oscillating drive signal VDRV has been provided to the transducer 102 for a first non-zero cleaning time. If not (NO at 1104), the controller 130 continues providing the oscillating drive signal VDRV to the transducer 102 in the first frequency range 721 at 1102. If the first cleaning time is completed (YES at 1104), the method 1100 continues at 1106 with providing the oscillating drive signal VDRV to the transducer 102 in the second frequency range 722 that includes a second non-zero resonant frequency 712 of the bimodal vibration frequency response of the lens 202, 302 for a second non-zero cleaning time. At 1108, the controller 130 determines whether the oscillating drive signal VDRV has been provided to the transducer 102 for the second non-zero cleaning time. If not (NO at 1108), the controller 130 continues providing the oscillating drive signal VDRV to the transducer 102 in the second frequency range 722 at 1106. If the second cleaning time is completed (YES at 1108), the cleaning cycle is completed at 1110, and the controller 130 discontinues providing the oscillating drive signal VDRV. In one example, the method 1100 also includes engaging the o-ring 208, 408 to the lens 202, 302 at a contact location so that an admittance response of the transducer 102 and the lens 202, 302 is maximized, and the resulting vibration level of the lens 202, 302 is maximum.

Modifications are possible in the described examples, and other implementations are possible, within the scope of the claims.

What is claimed is:

1. An apparatus, comprising:
a lens having a first side, a second side, and a lens radius;
a transducer having a transducer outer radius, the transducer being coupled to the first side of the lens and configured to vibrate the lens, the transducer outer radius being less than the lens radius; and
a driver having output terminals coupled to the transducer and configured to provide an oscillating drive signal at a non-zero frequency to vibrate the lens.

2. The apparatus of claim 1, further comprising an o-ring between a clamp and the second side of the lens, the o-ring having a nominal radius that is less than or equal to a nominal radius of the transducer.

3. The apparatus of claim 2, wherein the o-ring has a round cross section.

4. The apparatus of claim 2, wherein the o-ring has a rectangular cross section.

5. The apparatus of claim 2, wherein the driver is configured to perform a multiple frequency cleaning cycle that includes:
providing the oscillating drive signal in a first frequency range that includes a first non-zero resonant frequency of a bimodal vibration frequency response of the lens for a first non-zero cleaning time; and
providing the oscillating drive signal in a second frequency range that includes a second non-zero resonant frequency of the bimodal vibration frequency response of the lens for a second non-zero cleaning time.

6. The apparatus of claim 1, wherein the lens is flat.

7. The apparatus of claim 1, wherein the lens is curved.

8. The apparatus of claim 1, wherein the driver is configured to perform a multiple frequency cleaning cycle that includes:
providing the oscillating drive signal in a first frequency range that includes a first non-zero resonant frequency of a bimodal vibration frequency response of the lens for a first non-zero cleaning time; and
providing the oscillating drive signal in a second frequency range that includes a second non-zero resonant frequency of the bimodal vibration frequency response of the lens for a second non-zero cleaning time.

9. The apparatus of claim 1, wherein the transducer is glued to the first side of the lens.

10. The apparatus of claim 1, wherein: the transducer is a cylinder; and an axis (230) of the transducer is aligned with an axis of the lens.

11. An apparatus, comprising:
a lens having a first side and a second side;
a transducer having a nominal radius, the transducer being coupled to the first side of the lens and configured to vibrate the lens;
an o-ring between a clamp and the second side of the lens, the o-ring having a nominal radius that is less than or equal to the nominal radius of the transducer; and
a driver having output terminals coupled to the transducer and configured to provide an oscillating drive signal at a non-zero frequency to vibrate the lens.

12. The apparatus of claim 11, wherein the driver is configured to perform a multiple frequency cleaning cycle that includes:
providing the oscillating drive signal in a first frequency range that includes a first non-zero resonant frequency of a bimodal vibration frequency response of the lens for a first non-zero cleaning time; and
providing the oscillating drive signal in a second frequency range that includes a second non-zero resonant frequency of the bimodal vibration frequency response of the lens for a second non-zero cleaning time.

13. The apparatus of claim 11, wherein the lens is flat.

14. The apparatus of claim 11, wherein the lens is curved.

15. The apparatus of claim 11, wherein the transducer is glued to the first side of the lens.

16. The apparatus of claim 11, wherein the o-ring has a round cross section.

17. The apparatus of claim 11, wherein the o-ring has a rectangular cross section.

18. The apparatus of claim 11, wherein the driver is configured to perform a multiple frequency cleaning cycle that includes:
providing the oscillating drive signal in a first frequency range that includes a first non-zero resonant frequency of a bimodal vibration frequency response of the lens for a first non-zero cleaning time; and
providing the oscillating drive signal in a second frequency range that includes a second non-zero resonant frequency of the bimodal vibration frequency response of the lens for a second non-zero cleaning time.

19. A method, comprising:
providing an oscillating drive signal to a transducer configured to vibrate a lens in a first frequency range that includes a first non-zero resonant frequency of a bimodal vibration frequency response of the lens for a first non-zero cleaning time; and
providing the oscillating drive signal to the transducer configured to vibrate the lens in a second frequency range that includes a second non-zero resonant frequency of the bimodal vibration frequency response of the lens for a second non-zero cleaning time.

20. The method of claim 19, further comprising:
engaging an o-ring to the lens at a contact location so that an admittance response of the transducer and the lens is maximized, and a resulting vibration level of the lens is maximum.
